(19) United States
(12) Patent Application Publication
(10) Pub. No.: US 2024/0099523 A1
(43) Pub. Date: Mar. 28, 2024

(54) Field Latrine Assembly

(71) Applicant: Leonard Harmon, JR., Apple Valley, CA (US)

(72) Inventor: Leonard Harmon, JR., Apple Valley, CA (US)

(21) Appl. No.: 17/951,285

(22) Filed: Sep. 23, 2022

(51) Int. Cl. A47K 11/02; A01B 1/02; E04H 15/02; E04H 15/40; E04H 15/58

(52) U.S. Cl. CPC A47K 11/02; A01B 1/022; E04H 15/02; E04H 15/405; E04H 15/58

(57) ABSTRACT

A field latrine assembly for defecating in privacy in a remote location includes a pop up tent that has an entrance extending into an interior of the pop up tent thereby facilitating a user to enter the pop up tent. A foldable chair has a seat portion which has a hole thereby facilitating the user to defecate through the hole when the user sits on the seat portion. The foldable chair is positionable inside of the pop up tent when the pop up tent is in the deployed condition to facilitate the user to defecate in privacy. The foldable chair includes a pair of legs that is pivotally coupled to a frame. A duffel bag is included for storing the pop up tent, the foldable chair and the foldable shovel for storage.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to latrine devices and more particularly pertains to a new latrine device for defecating in privacy in a remote location. The device includes a pop up tent that is positionable over a hole in the ground. The device includes a foldable chair that has a seat portion with a hole to facilitate a user to defecate through the hole while sitting. The device includes a foldable shovel for digging the hole and a duffel bag for storing the pop up tent, the foldable chair and the foldable shovel.

### (2) Description of Related Art Including Information Disclosed Under 37 CFR 1.97 and 1.98

The prior art relates to latrine devices including a portable seat frame that includes shoulder straps and a fabric seat. The prior art discloses a backpack chair that includes a foldable frame and fabric panels extending across the foldable frame. The prior art discloses a variety of portable chairs that each at least includes a seat with a hole for facilitating a user to defecate through the hole when the user sits on the seat. The prior art discloses a portable commode chair that includes a commode chair with an anal plug and an irrigating bag fluidly attached to the anal plug for irrigation a user's colon.

### BRIEF SUMMARY OF THE INVENTION

An embodiment of the disclosure meets the needs presented above by generally comprising a pop up tent that has an entrance extending into an interior of the pop up tent thereby facilitating a user to enter the pop up tent. A foldable chair has a seat portion which has a hole thereby facilitating the user to defecate through the hole when the user sits on the seat portion. The foldable chair is positionable inside of the pop up tent when the pop up tent is in the deployed condition to facilitate the user to defecate in privacy. The foldable chair includes a pair of legs that is pivotally coupled to a frame. A duffel bag is included for storing the pop up tent, the foldable chair and the foldable shovel for storage.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a field latrine assembly according to an embodiment of the disclosure.

FIG. 2 is a front perspective view of an embodiment of the disclosure.

FIG. 3 is a perspective view of an embodiment of the disclosure.

FIG. 4 is a perspective in-use view of an embodiment of the disclosure.

### DETAILED DESCRIPTION OF THE INVENTION

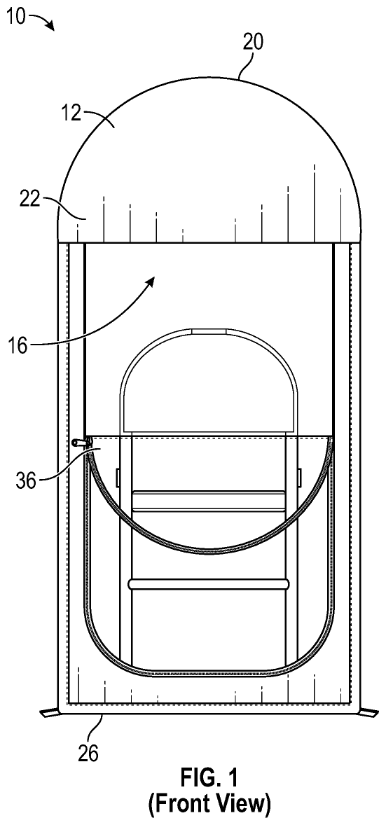

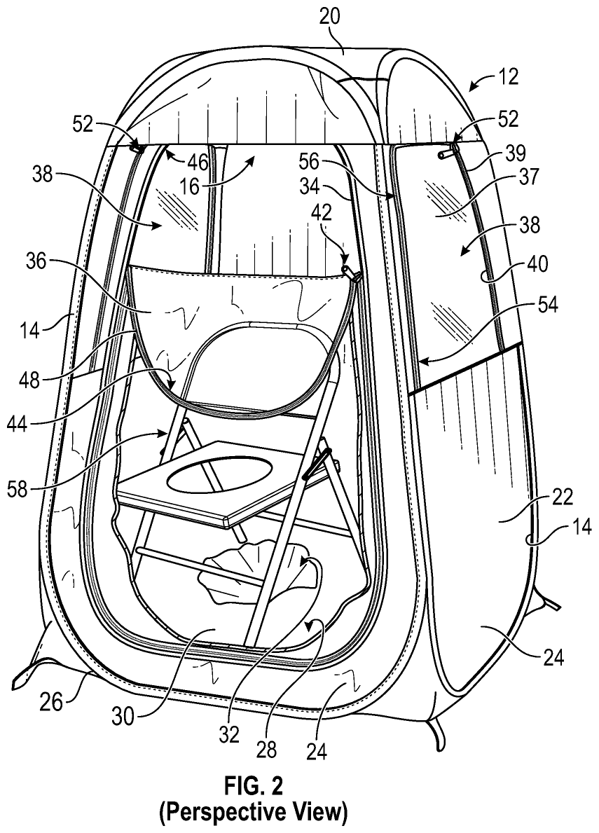

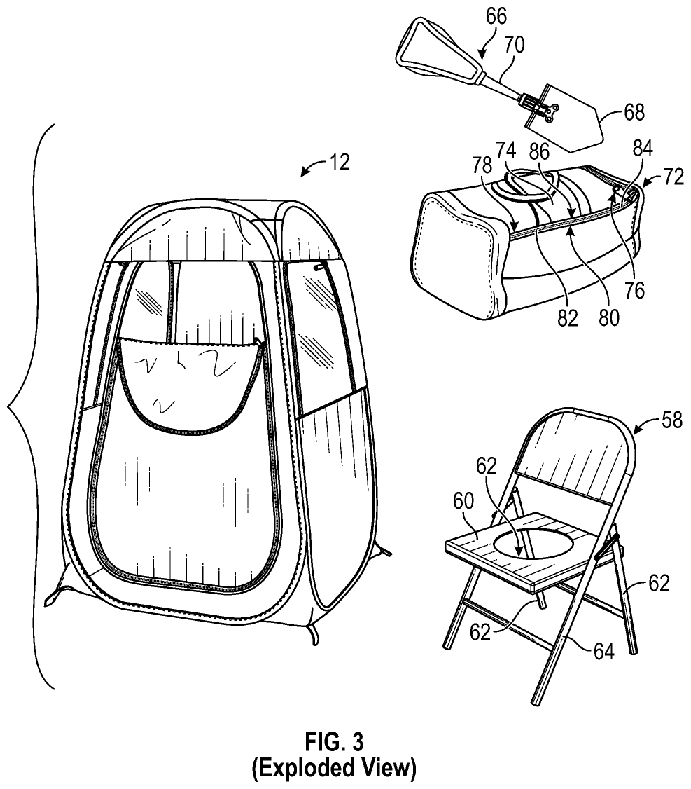

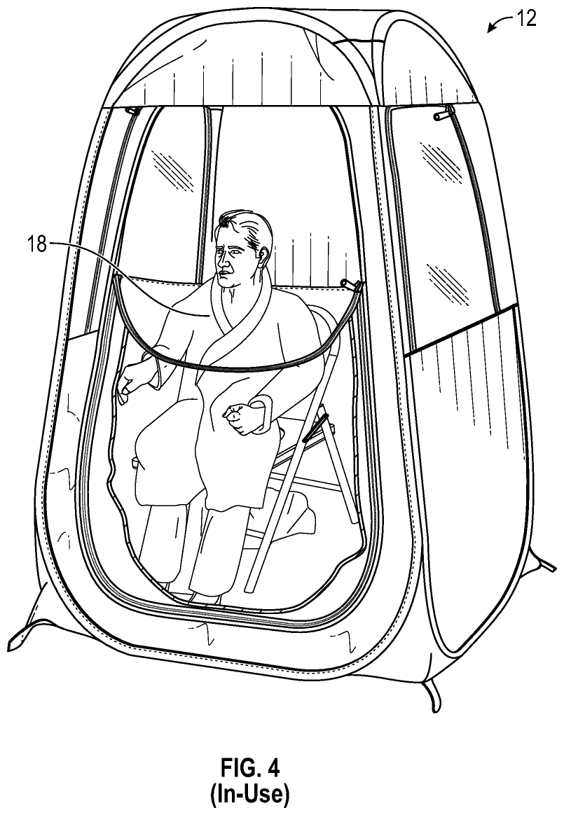

With reference now to the drawings, and in particular to FIGS. 1 through 4 thereof, a new latrine device embodying the principles and concepts of an embodiment of the disclosure and generally designated by the reference numeral 10 will be described.

As best illustrated in FIGS. 1 through 4, the field latrine assembly 10 generally comprises a pop up tent 12 that has a plurality of biasing members 14 being integrated into strategic locations in the pop up tent 12 for biasing the pop up tent 12 into a deployed condition. The pop up tent 12 is collapsible into a collapsed condition for storage. The pop up tent 12 has an entrance 16 extending into an interior of the pop up tent 12 thereby facilitating a user 18 to enter the pop up tent 12. In this way the pop up tent 12 facilitates privacy for the user 18 in a remote and outdoor location. The user 18 might be a soldier, for example, or other person that spends significant amounts of time in remote locations that do not have a bathroom facility.

The pop up tent 12 has a top wall 20 and an outer wall 22 extending downwardly from the top wall 20. The outer wall 22 has a height of at least 180.0 cm and a width of at least 90.0 cm. The outer wall 22 has a plurality of intersecting sides 24 and a lower edge 26 which defines an opening 28 to expose the ground 30 upon which the pop up tent 12 is positioned. In this way the pop up tent 12 exposes a hole 32 that was dug into the ground 30 upon which the pop up tent 12 is positioned.

The entrance 16 extends through a respective one of the plurality of intersecting sides 24 of the outer wall 22 and the entrance 16 has a bounding edge 34. The pop up tent 12 has a door 36 that is movably integrated into the pop up tent 12, and the door 36 is positionable in a closed position to close the entrance 16. The pop up tent 12 has a plurality of windows 38 each extending through a respective one of the intersecting sides 24 of the outer wall 22 of the pop up tent 12 and each of the windows 38 has a bounding edge 40 and each of the windows 38 includes a window flap 37 which has an outside edge 39.

A door closure 42 is integrated into pop up tent 12 and the door closure 42 has a first portion 44 that is releasably matable to a second portion 46. The door 36 has an outer edge 48 and the first portion 44 extends around the outer edge 48 of the door 36. The second portion 46 extends around the bounding edge 34 of the entrance 16 and the door 36 is retained in the closed position when the first portion 44 is mated to the second position. Conversely, the door 36 is positionable in an open position when the first portion 44 is unmated from the second portion 46. The door closure 42 may comprise a zipper or other type of releasable, mechanical closure.

A pair of window closures 52 is provided and each of the window closures 52 is integrated into pop up tent 12. Each of the window closures 52 has a primary portion 54 that is releasably matable to a secondary portion 56. The primary portion 54 of each of the window closures 52 extends around the bounding edge 40 of a respective window 38 and the secondary portion 56 of each the window closures 52 extends around the outside edge 39 of the window flap 37 of the respective window 38. The window flap 37 of the respective window 38 is retained in the closed position when the primary portion 54 of the respective window closure 52 is mated to the secondary portion 56 of the respective window closure 52. The window flap 37 of the respective window 38 is positionable in an open position when the primary portion 54 of the respective window closure 52 is unmated from the secondary portion 56 of the respective window closure 52. Each of the window closures 52 may comprise a zipper or other type of releasable, mechanical closure.

A foldable chair 58 is provided which has a seat portion 60 and a hole 62 extending through the seat portion 60. In this way the user 18 can defecate through the hole 32 in the seat portion 60 when the user 18 sits on the seat portion 60. Thus, the foldable chair 58 facilitates the user 18 to defecate in a seated position while in a remote location. The foldable chair 58 is positionable inside of the pop up tent 12 when the pop up tent 12 is in the deployed condition to facilitate the user 18 to defecate in privacy. Additionally, the foldable chair 58 includes a pair of legs 62 that is each pivotally coupled to a frame 64 and the seat portion 60 is comprised of a rigid material, including but not being limited to, plastic or metal.

A foldable shovel 66 is provided which has a blade 68 that is pivotally coupled to a handle 70 thereby facilitating the user 18 to grip the handle 70 for employing the blade 68 to dig the hole 32 in the ground 30. The blade 68 lies on a plane that is oriented parallel to a lengthwise axis of the handle 70 when the foldable shovel 66 is in an unfolded condition. Conversely, the blade 68 lies against the handle 70 when the foldable shovel 66 is in a folded condition. The foldable shovel 66 may be a foldable shovel that is issued to a soldier in the United States Army, for example, or other similar type of foldable shovel.

A duffel bag 72 is provided for storing the pop up tent 12 and the foldable chair 58 and the foldable shovel 66 for storage. The duffel bag 72 has a flap 74 that is movably into an open condition for accessing an interior of the duffel bag 72 and the flap 74 is movable into a closed condition for closing the duffel bag 72. A flap closure 76 is provided that has a first section 78 which is releasably matable to a second section 80. The flap 74 has a perimeter edge 82 and the first section 78 extends along the perimeter edge 82 of the flap 74. The second section 80 extends around an edge 84 of an opening 86 into the duffel bag 72 defined by the flap 74. The flap 74 is retained in the closed condition when the first section 78 is mated to the second section 80. Conversely, the flap 74 is movable into the open condition when the first section 78 is unmated from the second section 80.

In use, the foldable shovel 66 is employed to dig a hole 32 and the pop up tent 12 is deployed and positioned over the hole 32. The foldable chair 58 is positioned inside the pop up tent 12 such that the seat portion 60 of the foldable chair 58 is positioned over the hole 32. The door 36 is closed and the user 18 sits on the seat portion 60 to defecate into the hole 32. In this way the user 18 can defecate in seated position and in privacy in the remote location. The foldable chair 58 is removed from the pop up tent 12, the pop up tent 12 is collapsed and the hole 32 is filled back in. Continuing, each of the pop up tent 12, the foldable chair 58 and the foldable shovel 66 are placed into the duffel bag 72 for storage and transport. Each of the pop up tent 12 and the foldable chair 58 and the foldable shovel 66 may be cleaned and disinfected as necessary prior to being placed in the duffel bag 72.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A field latrine assembly for facilitating a user to defecate in a seated position while in a remote location, said assembly comprising:
a pop up tent having a plurality of biasing members being integrated into said pop up tent for biasing said pop up tent into a deployed condition, said pop up tent being collapsible into a collapsed condition for storage, said pop up tent having an entrance extending into an interior of said pop up tent thereby facilitating a user to enter said pop up tent wherein said pop up tent is configured to facilitate privacy for the user;
a foldable chair having a seat portion, said foldable chair having a hole extending through said seat portion thereby facilitating the user to defecate through said hole when the user sits on said seat portion wherein said foldable chair is configured to facilitate the user to defecate in a seated position while in a remote location, said foldable chair being positionable inside of said pop up tent when said pop up tent is in said deployed condition wherein said pop up tent is configured to facilitate the user to defecate in privacy, said foldable chair including a pair of legs being pivotally coupled to a frame; and
a duffel bag for storing said pop up tent and said foldable chair and said foldable shovel for storage.

2. The assembly according to claim 1, wherein:
said pop up tent has a top wall and an outer wall extending downwardly from said top wall, said outer wall having a plurality of intersecting sides and a lower edge defining an opening to expose the ground upon which said pop up tent is positioned wherein said pop up tent is configured to expose a hole dug into the ground upon which said pop up tent is positioned;
said entrance extends through a respective one of said intersecting sides of said outer wall, said entrance having a bounding edge;
said pop up tent has a door being movably integrated into said pop up tent, said door being positionable in a closed position to close said entrance, said door having an outer edge; and
said pop up tent has a plurality of windows each extending through a respective one of said intersecting sides of said outer wall of said pop up tent, each of said windows having a bounding edge, each said windows having a window flap having an outside edge.

3. The assembly according to claim 2, further comprising a door closure being integrated into pop up tent, said door closure having a first portion being releasably matable to a second portion, said first portion extending around said outer edge of said door, said second portion extending around said bounding edge of said entrance, said door being retained in said closed position when said first portion is mated to said second position, said door being positionable in an open position when said first portion is unmated from said second portion.

4. The assembly according to claim 2, further comprising a pair of window closures, each of said window closures being integrated into pop up tent, each of said window closures having a primary portion being releasably matable to a secondary portion, said primary portion each of said window closures extending around said bounding edge of a respective one of said windows, said secondary portion of said respective window closure extending around said outside edge of said window flap of said respective window, said window flap of said respective window being retained in said closed position when said primary portion of said respective window closure is mated to said secondary portion of said respective window closure, said window flap of said respective window being positionable in an open position when said primary portion of said respective window closure is unmated from said secondary portion of said respective window closure.

5. The assembly according to claim 1, further comprising a foldable shovel having a blade being pivotally coupled to a handle thereby facilitating the user to grip said handle for employing said blade to dig the hole in the ground, said blade lying on a plane being oriented parallel to a lengthwise axis of said handle when said foldable shovel is in a unfolded condition, said blade lying against said handle when said foldable shovel is in a folded condition.

6. The assembly according to claim 1, wherein:
said duffel bag has a flap being movably into an open condition for accessing an interior of said duffel bag, said flap being movable into a closed condition for closing said duffel bag, said flap having a perimeter edge; and
said assembly includes a flap closure having a first section being releasably matable to a second section, said first section extending along said perimeter edge of said flap, said second section extending around an edge of an opening into said duffel bag defined by said flap, said flap being retained in said closed condition when said first section is mated to said second section, said flap being movable into said open condition when said first section is unmated from said second section.

7. A field latrine assembly for facilitating a user to defecate in a seated position while in a remote location, said assembly comprising:
a pop up tent having a plurality of biasing members being integrated into said pop up tent for biasing said pop up tent into a deployed condition, said pop up tent being collapsible into a collapsed condition for storage, said pop up tent having an entrance extending into an interior of said pop up tent thereby facilitating a user to enter said pop up tent wherein said pop up tent is configured to facilitate privacy for the user, said pop up tent having a top wall and an outer wall extending downwardly from said top wall, said outer wall having a plurality of intersecting sides and a lower edge defining an opening to expose the ground upon which said pop up tent is positioned wherein said pop up tent is configured to expose a hole dug into the ground upon which said pop up tent is positioned, said entrance extending through a respective one of said intersecting sides of said outer wall, said entrance having a bounding edge, said pop up tent having a door being movably integrated into said pop up tent, said door being positionable in a closed position to close said entrance, said door having an outer edge, said pop up tent has a plurality of windows each extending through a respective one of said intersecting sides of said outer wall of said pop up tent, each of said windows having a bounding edge, each said windows having a window flap having an outside edge;
a door closure being integrated into pop up tent, said door closure having a first portion being releasably matable to a second portion, said first portion extending around said outer edge of said door, said second portion extending around said bounding edge of said entrance, said door being retained in said closed position when said first portion is mated to said second position, said door being positionable in an open position when said first portion is unmated from said second portion;
a pair of window closures, each of said window closures being integrated into pop up tent, each of said window closures having a primary portion being releasably matable to a secondary portion, said primary portion each of said window closures extending around said bounding edge of a respective one of said windows, said secondary portion of said respective window closure extending around said outside edge of said window flap of said respective window, said window flap of said respective window being retained in said closed position when said primary portion of said respective window closure is mated to said secondary portion of said respective window closure, said window flap of said respective window being positionable in an open position when said primary portion of said respective window closure is unmated from said secondary portion of said respective window closure;
a foldable chair having a seat portion, said foldable chair having a hole extending through said seat portion thereby facilitating the user to defecate through said hole when the user sits on said seat portion wherein said foldable chair is configured to facilitate the user to defecate in a seated position while in a remote location, said foldable chair being positionable inside of said pop up tent when said pop up tent is in said deployed condition wherein said pop up tent is configured to facilitate the user to defecate in privacy, said foldable chair including a pair of legs being pivotally coupled to a frame;
a foldable shovel having a blade being pivotally coupled to a handle thereby facilitating the user to grip said handle for employing said blade to dig the hole in the ground, said blade lying on a plane being oriented parallel to a lengthwise axis of said handle when said foldable shovel is in a unfolded condition, said blade lying against said handle when said foldable shovel is in a folded condition;
a duffel bag for storing said pop up tent and said foldable chair and said foldable shovel for storage, said duffel bag having a flap being movably into an open condition for accessing an interior of said duffel bag, said flap being movable into a closed condition for closing said duffel bag, said flap having a perimeter edge; and
a flap closure having a first section being releasably matable to a second section, said first section extending along said perimeter edge of said flap, said second section extending around an edge of an opening into said duffel bag defined by said flap, said flap being retained in said closed condition when said first section is mated to said second section, said flap being movable into said open condition when said first section is unmated from said second section.
